(19) United States
(12) Patent Application Publication
(10) Pub. No.: US 2020/0089583 A1
(43) Pub. Date: Mar. 19, 2020

(54) CONFIGURATION AND METHOD TO GUARANTEE HIGH INTEGRITY DATA IN A REDUNDANT VOTING DATA SYSTEM

(71) Applicant: Mitchell S. Fletcher, Glendale, AZ (US)

(72) Inventor: Mitchell S. Fletcher, Glendale, AZ (US)

(21) Appl. No.: 16/136,056

(22) Filed: Sep. 19, 2018

(51) Int. Cl. G06F 11/16; G06F 11/18; G06F 11/20

(52) U.S. Cl. CPC G06F 11/1633; G06F 11/2002; G06F 11/187; G06F 11/1625

(57) ABSTRACT

Devices systems and methods are disclosed providing a highly fault tolerant Command, Control, and Data Handling (CC&DH) system immune to byzantine faults. The system includes a plurality of High Integrity Computing Elements each capable of delivering data immune to byzantine faults, an arbitrary communication interface, and a number of peripheral devices providing input and output to the system. The system is capable of providing high integrity data immune to byzantine faults throughout the system. Using one greater High Integrity Computing Elements than the number of faults required allows for implementation of a wide range of redundant systems including dual, triple, quad, and beyond redundancy using voting computers. The system is implemented using any number of standard computing elements, which is greater than two, a communication abstraction, data exchange, mission algorithm, and data comparison producing data immune to byzantine errors to the remaining peripherals in the system.

### TECHNICAL FIELD

The present invention generally relates to the creation of a highly fault tolerant Command, Control, and Data Handling (CC&DH) system consisting of a Reliable Computing Complex [300 of FIG. 5 and FIG. 6] which is immune to byzantine faults, consisting of a generic set of voting computers communicating with a set of peripherals. More specifically the present invention relates to implementation and method to create byzantine immune data exiting an arbitrary number of command and control voting computer elements [301] [302] [303], where the number of computing elements is greater than two. This is implemented using any number of standard computing elements, which is greater than two, with the intention to receive data from sensors [52] [62] [72] via a communication abstraction [340], perform cross-element data exchange, execute any mission specific algorithm(s), complete data comparison producing guaranteed known good data validity immune to byzantine errors to a communication abstraction and thus high integrity data, immune to byzantine faults, to the remaining peripherals [50] [60] [800] [900] in the system.

### BACKGROUND

An Electronic Control System (ECS) is any embedded system containing electronics that controls one or more of the electrical systems or subsystems in a vehicle. Types of ECS include, Powertrain, Transmission, Brake Control, Engine control, along with all the modern in dash operations in today's automobiles, Avionics (which are the electronic systems used on aircraft, artificial satellites, and spacecraft including communications, navigation, the display and management of multiple systems, and the hundreds of systems that are fitted to aircraft to perform individual functions), weapon systems in military aircraft, tanks, and ships, and other applications too numerous to list. In a Command, Control, and Data Handling (CCD&H) system, a single board computer or other controller typically communicates with various peripheral devices through an interface device connected through a backplane or a bus which may be a serial or parallel implementation. Most systems communicate to a number of elements; either directly to peripheral devices or through a Peripheral Control Unit (PCU) containing circuit boards which in turn communicate to various peripheral devices. In the case of a PCU, each circuit board within the PCU is in turn associated with one or more peripheral devices.

Once configured, system operation typically requires a software program and specific driver software corresponding to each type of peripheral that is used in the system. This software is located in the single board computer, which allows the computer's operating system to communicate with and control the peripheral device. This control can be directly to the peripheral or through a Peripheral Control Unit (PCU). At times, the addition or change of a peripheral device will require a new interface which would then typically require a new device driver before the peripheral device and interface device can be operated by the single board computer.

A computing device with a robust level of intelligence is usually required to communicate with each interface device. This allows data to be received, stored, transmitted, and appropriately formatted for transmission to and from the appropriate destinations via a communication abstraction typically implemented as wireless communication, a backplane, or a bus. Commonly such functions were conducted by processors or controllers with data formatting capability that allowed communication of command/response logic instructions that were created by a complex computer program that was compiled and linked to a board support package library function.

For highly sophisticated applications such as for avionics, the controller may be required to be inspected and its conditional logic certified to be error free. It is known that device failures can cause incorrect data to be introduced to the system. These failures can happen at the input peripheral, the communication abstraction, the processing element including the support devices which comprise the control element, or the output peripheral. To eliminate these failures in a high integrity system, redundant components are introduced for peripheral devices, communication paths, and control elements. Those skilled in the art will recognize that redundant elements can be implemented using multiple methods, including, but not limited to self checking pairs, voting computers, polynomial progression encoding, Error Detection And Correction (EDAC), and Cyclic Redundancy Check (CRC)s. Those skilled in the art will also recognize that assuring byzantine immune data at the boundaries of the control unit, the communication abstraction, and the peripheral devices typically require complex implementations. Because the number of components is limited in the boundary implementation, many systems do not extend the fault tolerance to the boundary implementation.

All current art implementations using voting control units do not provide high interiority byzantine immune data from the processing element to the communication abstraction. Currently existing art for Command, Control, and Data Handling (CC&DH) systems consist of redundant channels each comprised of sensors [52] [62] [72] all of FIG. 1], effectors [50] [60], and a set of Control Elements [101] [102] [103] that exchange data using a cross channel data link [12] [13] [23]. The cross channel data link assures integrity of sensor data and execution of the application specific algorithm, but byzantine error can be introduced by the CPU [110 of FIG. 2.], the CPU support devices [111] [112] [113], interface and control [160] [180], and the Input/Output circuits [1501] [1511] [1502] [1512]. Additionally, there is a perception in the industry that control devices implemented using self-checking pairs, or that implement EDAC and polynomial progression encoding schemes are overly expensive, require long duration development, or are proprietary. Hence, there is a need for a Reliable Computing Complex that produces high integrity byzantine immune data consisting of Off the Shelf (OTS) or other low cost control elements. An obvious extension of the existing art is to replace the Input/Output interface [1501] [1502 of FIG. 2.] with a communication abstraction interface [283] [285] [290 all of FIG. 4], and communicate to a communication abstraction [241] [242] [243 of FIG. 3] which in turn communicates to a Peripheral Control Unit (PCU) [1500] [1600] [1700 of FIG. 3.], containing the Input/Output circuits [1501] [1511] [1502] [1512 of FIG. 3].

### BRIEF SUMMARY

A high integrity fault tolerant data system is provided that includes a Reliable Computing Complex [300], a Communication Abstraction [340], a High Integrity Peripheral Control Unit [500] [600] [700 all of FIG. 5], a Standard Integrity Peripheral Control Unit [1500] [1600] [1700 all of FIG. 6], and peripheral sensors [52] [62] [72] and effectors [50] [60] where the Reliable Computing Complex is implemented as a redundant set of Computing Elements [301] [302] [303 all of FIG. 5 and FIG. 6] where the number of Computing Elements (CE) is greater than two. Additionally, the Computing Element (CE) which is composed of a Central Processing Unit [350 of FIG. 7] (CPU), necessary components to support the CPU [351] [352] [353], cross channel data link [370] [371] [372] [373], and high integrity interface [380] [381] [382] [383] [384] [385] [386] [388] [390] to the communication abstraction. Further, the CPU may be implemented as a state machine, a bit slice processor, an Application-specific Instruction Set Processor (ASIP), a Graphics Processing Unit (GPU), a Physics Processing Unit (PPU), a Digital Signal Processor (DSP), an Image Processor, an Analog Computer, or other means as those skilled in the art would recognize. The CE also embodies a method [400 of FIG. 8.] for acquiring information from redundant peripheral sensors, a means for data interchange between the other CE devices within the redundant voting set, and a method to assure that data exiting the CE to the peripheral effectors through the communication abstraction consists of high integrity data immune to byzantine faults.

A method [400 of FIG. 8.] is provided for producing high integrity byzantine immune data. The method comprises the steps executed by the CPU composed of receiving data from peripheral sensors [406], exchange of the sensor information with the other CE devices in the redundant voting set [408] [410], performing a sensor validity algorithm [412], execution of any mission specific algorithm [414], exchange the data from the mission specific algorithm [416] [418], and verify the data presented to the peripheral effectors through the communication abstraction consists of high integrity data immune to byzantine faults [420] [422] [424] [426] [428] [430] [432].

A system is provided for interfacing a Reliable Computing Complex [300 of FIG. 4. and FIG. 5.] consisting of greater than two Computing Elements [301] [302] [303] to peripheral sensors [52] [62] [72] and effectors [50] [60 all of FIG. 5] through a communication abstraction [340] and optional Peripheral Control Units [500] [600] [700] [1500] [1600] [1700]. Additionally, a High Integrity Computing Element [301] [302] [303] is provided consisting of a Central Processing Unit [350] (CPU), necessary components to support the CPU [351] [352] [353], Cross Channel Data Link [370] [371] [372] [373], and high integrity interface [381] [382] [383] [384] [385] [386] [388] [390 all of FIG. 7] to the communication abstraction [340]. Additionally, both a High Integrity Peripheral Control Unit [500] [600] [700] and a Standard Integrity Peripheral Control Unit [1500] [1600]] [1700] are provided consisting of a CPU [510] [610] [710] [1510] [1610] [1710], necessary components to support the CPU, communication lanes between the CPU and Input/Output (IO) cards and IO cards [501] [502] [601] [602] [701] [702] [1501] [1502] [1601] [1602] [1701] [1702].

### BRIEF DESCRIPTION OF THE DRAWINGS

The present invention will hereinafter be described in conjunction with the following drawing figures, wherein like numerals denote like elements.

FIG. 1 is a block diagram of existing art depicting a fault tolerant Command, Control, and Data Handling (CC&DH) system consisting of redundant Compute Elements.

FIG. 2 is a block diagram of existing art of a Computing Element (CE) with an integrated Cross Channel Data Link.

FIG. 3 is a block diagram of existing art depicting a fault tolerant Command, Control, and Data Handling (CC&DH) system consisting of redundant Compute Elements with the obvious improvement adding a communication abstraction and distributed Input/Output enabled by a Peripheral Control Unit (PCU).

FIG. 4 is a block diagram of existing art of a Computing Element (CE) with an integrated Cross Channel Data Link with the obvious addition of circuitry necessary for communication with a communication abstraction.

FIG. 5 is a block diagram of an exemplary fault tolerant Command, Control, and Data Handling (CC&DH) system with a High Integrity Peripheral Control Unit (HPCU).

FIG. 6 is a block diagram of an exemplary fault tolerant Command, Control, and Data Handling (CC&DH) system with a Standard Integrity Peripheral Control Unit (SPCU).

FIG. 7 is a simplified block diagram of an exemplary fault tolerant High Integrity Compute Element (CE).

FIG. 8 is a simplified is a flow chart depicting one embodiment of a method to implement the necessary independent data movement within the High Integrity Computing Element (CE) to assure that the fault tolerant system produces data that is immune to byzantine failures.

FIG. 9 is an example of the information at various steps of the method [400] of FIG. 8 demonstrating guarantee of byzantine error free results at the final output step.

### DETAILED DESCRIPTION

The following detailed description is merely explanatory in nature and is not intended to limit the invention or the application and uses of the invention. Furthermore, there is no intention to be bound by any theory presented in the preceding background or the following detailed description. Nor is there an intention to be bound by a particular data source.

The subject matter presented herein discloses methods, apparatus and systems that implement a fault tolerant Command, Control, and Data Handling (CC&DH) system featuring a Reliable Computing Complex comprised a plurality of greater than two Compute Elements (CE) comprising data exchange capability and utilizing voting to provide data immune to a byzantine failure that is intended to control a plurality of external peripheral devices via a communication abstraction. The CC&DH may be implemented using any number of choices of a communication abstraction including, but not limited to Ethernet, Time Triggered Gigabit Ethernet (TTGbE), wireless 802.11c, 1553B, and SpaceWire. Optionally, a Peripheral Control Unit (PCU) may be used to provide signal conditioning and/or data formatting to the peripheral devices. This CC&DH is a system that can be easily certified to be error free, easily updated, and only requires minimal certification effort, if such certification is necessary.

More specifically the present invention relates to apparatus and method to create byzantine error immune data exiting an arbitrary number of command and control voting computer elements, where the number of computing elements is greater than two. This is implemented using any number of standard computing elements, which is greater than two, with the intention to receive data from sensors via a communication abstraction, perform cross-element data exchange, execute any mission specific algorithm, and complete data comparison producing guaranteed data validity presents at a communication abstraction and thus high integrity data, which is immune to byzantine faults, to the remaining peripherals in the system.

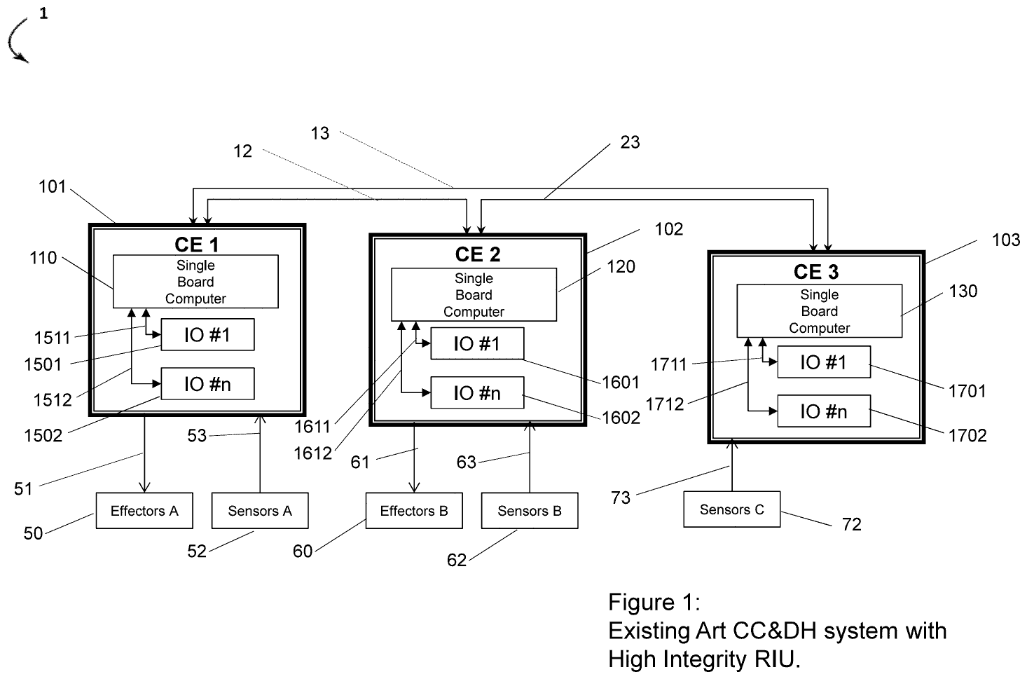

Turning to FIG. 1, a functional block diagram of existing art encapsulating the apparatus for a fault tolerant Command, Control, and Data Handling (CC&DH) system [1] with integrated Input/Output [1501] [1502] [1601] [1602] [1701] [1702] is depicted. The CC&DH system [1] receives sensor data from Sensors [52] [62] [72] and controls peripherals [50] [60] through interface connection [53] [63] [73] and interface connection [51] [61] respectively. Control of the CC&DH system [1] is mechanized with a plurality, but not less than two, Computing Elements [101] [102] [103] containing integrated Input/Output [1501] [1502] [1601] [1602] [1701] [1702] with Cross Channel Data Link (CCDL) [112] [113] [123] interconnecting each Computing Element [101] [102] [103]. A minimum or three Computing Elements [101] [102] [103] are required for single fault tolerance while four are required for double fault tolerance; five are required for triple fault tolerance, and so forth. Each Computing Element [101] [102] [103] communicates indirectly to sensors [52] [62] [72] and controls peripherals [50] [60] through the integrated Input/Output [1501] [1502] [1601] [1602] [1701] [1702] included. In the example, byzantine errors can enter the system after the CCDL due to failures in the hardware of each Computing Element [101] [102] [103]. This existing art is also limited to creating fault isolation zones corresponding to each of the CE devices meaning that any failure in CE 1 [101] results in loss of sensors [51] and effectors [50].

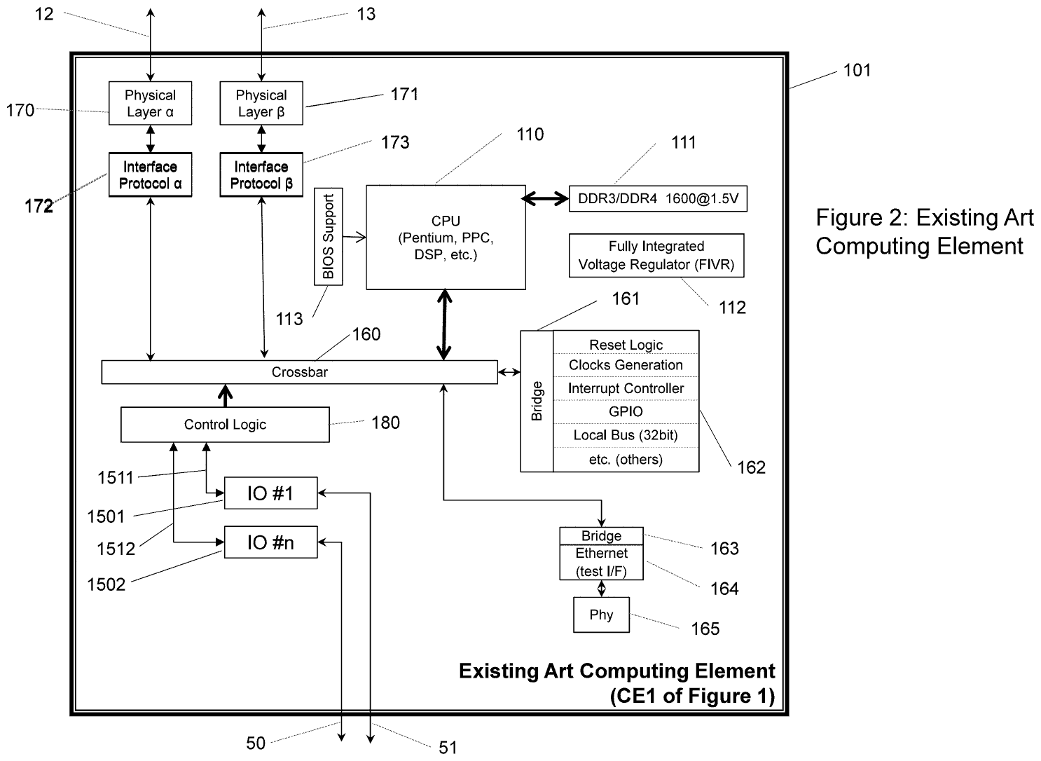

Focusing on FIG. 2, a functional block diagram of existing art encapsulating an apparatus for a Computing Elements [101] with Cross Channel Data Link (CCDL) [11] [12] controlled by a Central Processing Unit [110] and the devices necessary devices [111] [112] [113] [160] [161] [162] to support the CPU [110] operation. It should be appreciated by those of ordinary skill in the art of single board computer design or system on chip design will recognize that the implementation of the CPU [110] and the CPU support devices [111] [112] [113] [160] [161] [162] are existing art and can be implemented in many alternative configurations. Additionally a test interface consisting or a data bridge [163], Ethernet [164], and Physical Layer [165] are provided. Cross Channel Data Link consists of multiple channels which must be one less than the number of Computing Elements [101] [102] [103]. Each channel of CCDL consist of Interface Protocol [172] [173] and a Physical Layer [170] [171]. Cross channel data link implementations are common in the community and can be implemented by those with skill in the art. Exemplary examples of their implementation include the Draper Laboratory Network Element and the Space Launch System computers. The integrated Input/Output function is implemented with control logic [180] communicating to any number of peripheral interface shown in the example as IO #1 [1501] and IO #2 [1502]. The connection between the control logic and the peripheral interface can be implemented as a bus or as point-to-point connections [1511] [1512]. Exemplary examples include cPCI, VME, SpaceWire, and many others.

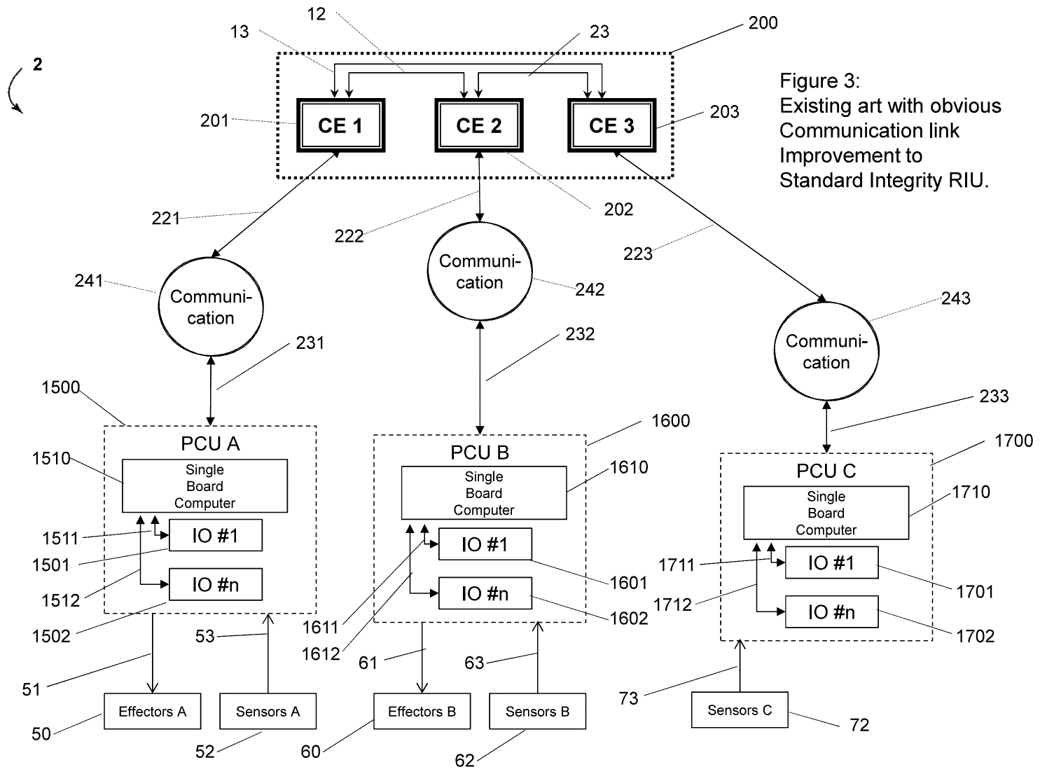

Alternately, FIG. 3 presents a functional block diagram of existing art encapsulating the apparatus for a fault tolerant Command, Control, and Data Handling (CC&DH) system [2] with distributed Input/Output provided by the addition of a communication abstraction [241] [242] [243] and a Standard Integrity Peripheral Control Unit (SPCU) [1500] [1600] [1700]. The CC&DH system [2] receives sensor data from Sensors [52] [62] [72] and controls peripherals [50] [60] through interface connection [53] [63] [73] and interface connection [51] [61] respectively. Control of the CC&DH system [2] is accomplished through a Reliable Computing Complex [200] consisting of a plurality, but not less than two, Computing Elements] [201] [202] [203] with Cross Channel Data Link (CCDL) [12] [13] [23] interconnecting each Computing Element] [201] [202] [203]. A minimum of three Computing Elements [201] [202] [203] are required for single fault tolerance while four are required for double fault tolerance; five are required for triple fault tolerance, and so forth.

The Reliable Computing Complex [200] communicates directly to each communication abstraction [241] [242] [243] through interface connections [221] [222] [223]. The communication abstraction [241] [242] [243] may be implemented using any number of choices of a including, but not limited to Ethernet, Time Triggered Gigabit Ethernet (TTGbE), wireless 802.11c, 1553B, SpaceWire, GPIB (IEEE-488). Optionally, a Peripheral Control Unit (PCU) [1500] [1600] [1700] may be used to provide signal conditioning and/or data formatting to the peripheral devices [50] [52] [60] [62] [72]. In the example, the communication abstractions [241] [242] [243] comprises, but is not limited to a high integrity TTGbE switch. Each communication abstraction [241] [242] [243] communicates directly the corresponding PCU using connection [231] [232] [233], that is CE 1 [201] communicates to PCU A [1500] using communication abstraction [241]. Alternately, each CE [201] [202] [203] could communicate to a single communication abstraction [not shown] which in turn communicate to the plurality of PCU [1500] [1600] [1700] device or alternately directly to peripheral devices. This existing art is capable of implementing limited fault isolation zones corresponding to each of the CE device, meaning that any failure in CE 1 [201] results in loss of sensors [51] and effectors [50], or having the Computing Complex [200] comprising one fault zone and each of the PCU devices comprising separate fault isolation zones, meaning that any failure in CE 1 [201] does not result in loss of sensors [51] and effectors [50]. This obvious improvement to existing art is also limited in that byzantine errors can enter the system after the CCDL due to failures in the hardware of each Computing Element [201] [202] [203], communication abstraction [241] [242] [243], and in the PCU [1500] [1600] [1700] apparatus.

Each Peripheral Control Unit [1500] [1600] [1700] is comprised of a Single Board Computer [1510] [1610] [1710] communicating with an arbitrary number of Input Output functions [1501] [1502] [1601] [1602] [1701] [1702] over in internal parallel or serial interface connections [1511] [1512] [1611] [1612] [1711] [1712]. Those skilled in the art will recognize that each of the single board computer [1510] [1610] [1710] could be replaced with an alternate computing element such as a microcontroller, digital signal processor, or other. In the example, the interface connections [1511] [1512] [1611] [1612] [1711] [1712] comprises, but is not limited to a single lane PCIe. Those familiar with interconnects used in modern computers recognize that these interface connections could be implemented as cPCI, VME, SpaceWire, and many others. Many implementations of SPCU devices [1500] [1600] [1700] are available as catalog items from manufactures such as AiTech and SEAKR among others.

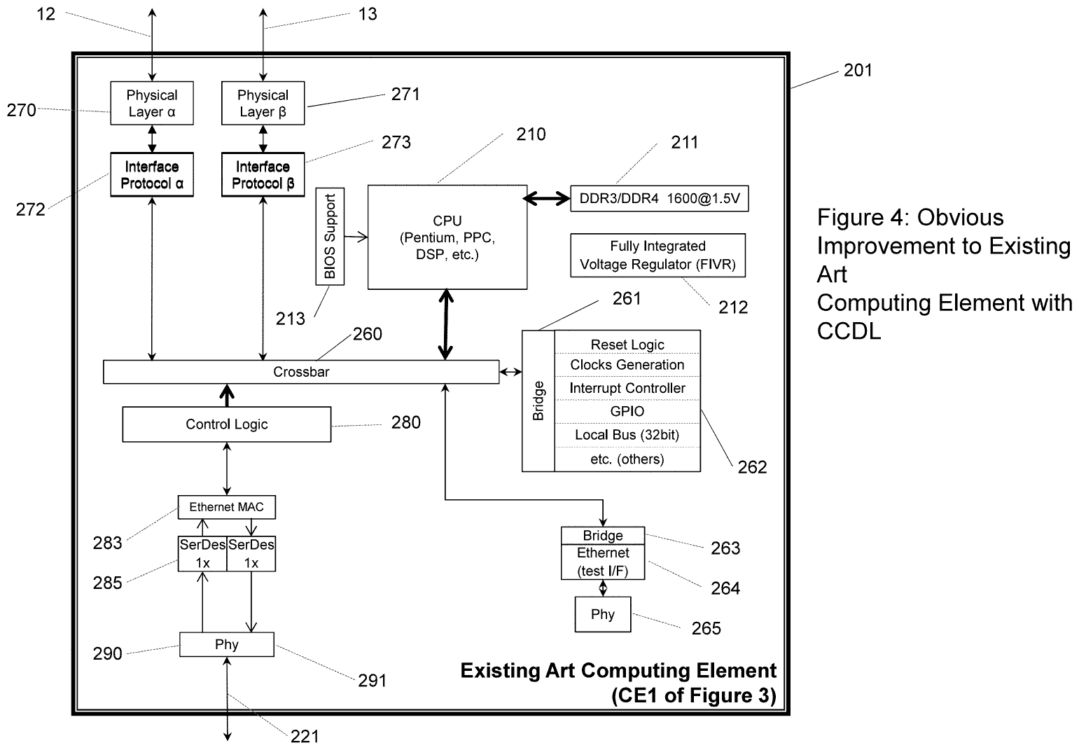

Focusing on FIG. 4, a functional block diagram of existing art encapsulating an apparatus for a Computing Elements [201] with Cross Channel Data Link (CCDL) [12] [13] controlled by a Central Processing Unit [210] and the devices necessary devices [211] [212] [213] [260] [261] [262] to support the CPU [210] operation. It should be appreciated by those of ordinary skill in the art of single board computer design or system on chip design will recognize that the implementation of the CPU [210] and the CPU support devices [211] [212] [213] [260] [261] [262] are existing art and can be implemented in many alternative configurations. Additionally a test interface consisting or a data bridge [263], Ethernet [264], and Physical Layer [265] are provided. Cross Channel Data Link consists of multiple channels which must be no less than the number of Computing Elements [201] [202] [203] less one. Each channel of CCDL consist of Interface Protocol [272] [273] and a Physical Layer [270] [271]. Cross channel data link implementations are common in the community and can be implemented by those with skill in the art. Exemplary examples of their implementation include the Draper Laboratory Network Element and the Space Launch System computers.

The obvious improvement is enabled by replacing the integrated Input/Output of FIG. 2. with apparatus to interface with the communication abstraction [241]. In the example block diagram, data presented to communication interface [221] consists of a single channel consisting of Ethernet MAC [283] and serial to digital converter (SerDes)] [285]. Those skilled in the art of communication will recognize that many alternates such as, but not limited to, SpaceWire, PCI Express, and Rapid IO could be implemented as the communication abstraction [241] [242] [243] requiring corresponding implementation in CE [201] [202] [203].

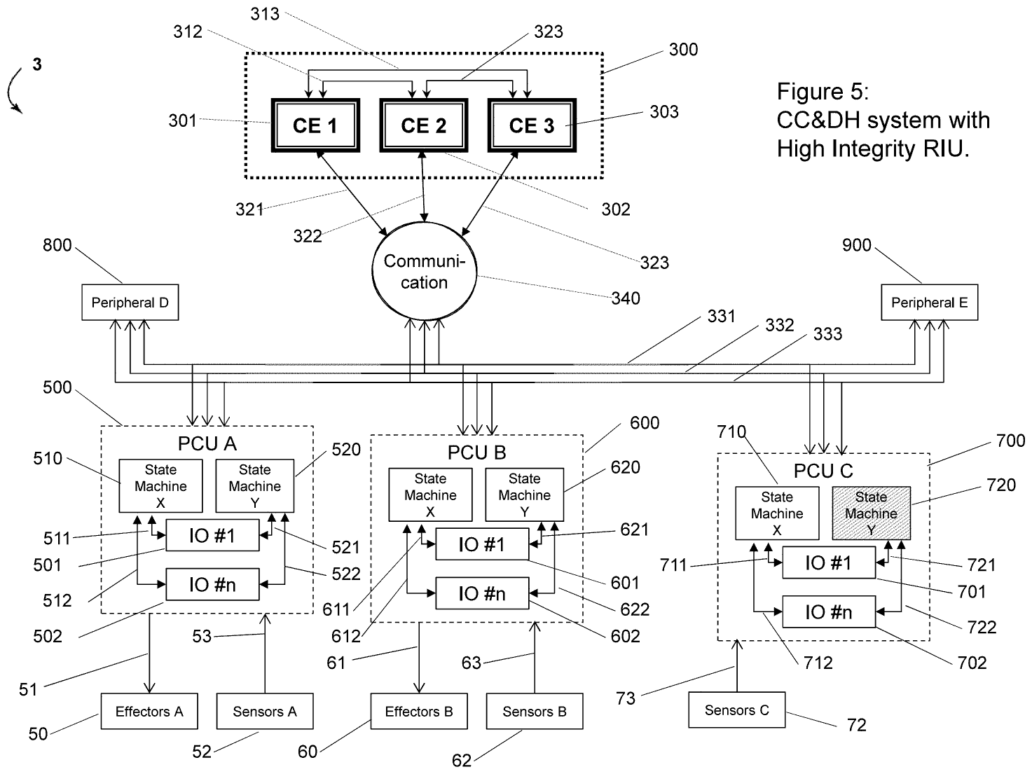

Turning to FIG. 5, a functional block diagram of the new exemplary fault tolerant Command, Control, and Data Handling (CC&DH) system with a High Integrity Peripheral Control Unit (HPCU) [500] [600] [700] providing byzantine error free data is depicted. The provided CC&DH system [3] receives sensor data from Sensors [52] [62] [72], and controls peripherals] [50] [60] through interface connection] [53] [63] [73] and interface connection] [51] [61] respectively in addition to direct control of Peripheral devices [800] [900] capable of interface to the communication abstraction [340]. Control of the CC&DH system [3] is accomplished through the Reliable Computing Complex [300] consisting of a plurality, but not less than two, Computing Elements [301] [302] [303] with Cross Channel Data Link (CCDL) [312] [313] [323] interconnecting each Computing Element [301] [302] [303]. A minimum or three Computing Elements [301] [302] [303] are required for single fault tolerance while four are required for double fault tolerance; five are required for triple fault tolerance, and so forth. The Reliable Computing Complex [300] communicates directly to a communication abstraction [340] through interface connection [321] [322] [323] which consist of data that is immune to byzantine failures. The communication abstraction [340] may be implemented using any number of choices of a including, but not limited to Ethernet, Time Triggered Gigabit Ethernet (TTGbE), wireless 802.11c, 1553B, SpaceWire, GPIB (IEEE-488). Optionally, a High Integrity Peripheral Control Unit (HPCU) [500] [600] [700] may be used to provide signal conditioning and/or data formatting to the peripheral devices [50] [52] [60] [62] [72]. In the example, the communication abstraction [340] comprises, but is not limited to a high integrity TTGbE switch. The communication abstraction [340] communicates directly to a plurality of HPCU [500] [600] [700] device or alternately directly to peripheral devices using connections [331] [332] [333]. Use of a high integrity TTGbE switch as the communication abstraction [340] provides data that is immune to a byzantine data to the HPCU [500] [600] [700].

Each High Integrity Peripheral Control Unit (HPCU) [500] [600] [700] is comprised of a State Machine X [510] [610] [710] communicating with an arbitrary number of Input Output functions [501] [502] [601] [602] [701] [702] over an internal parallel or serial interface connections [511] [512] [611] [612] [711] [712]. Each HPCU [500] [600] [700] is comprised of a State Machine Y [520] [620] [720] communicating with an the same number of Input Output functions [501] [502] [601] [602] [701] [702] as for the State Machine X [510] [610] [710] over an internal parallel or serial interface connections [521] [522] [621] [622] [721] [722]. For HPCU [700] limited to interconnect only with sensors [72], the State Machine Y [720] along with interconnect [721] [722] provide no additional benefit and may be eliminated. Those skilled in the art will recognize that each of the state machines [510] [520] [610] [620] [710] [720] could be replaced with an alternate computing element such as a microprocessor, or other. The exemplary example of a state machine [510] [520] [610] [620] [710] [720] eliminates common mode errors in the HPCU [500] [600] [700]. In the example, the interface connections [511] [512] [521] [522] [611] [612] [621] [622] [711] [712] [721] [722] comprises, but is not limited to a single lane PCIe. Those familiar with interconnects used in modern computers recognize that these interface connections could alternately be implemented as cPCI, VME, SpaceWire, and many others. Many implementations of HPCU devices [500] [600] [700] are available with exemplary examples being the Space Shuttle Multiplexer/Demultiplexer (MDM), The Space Station MDM, and the Orion Payload Data Unit (PDU).

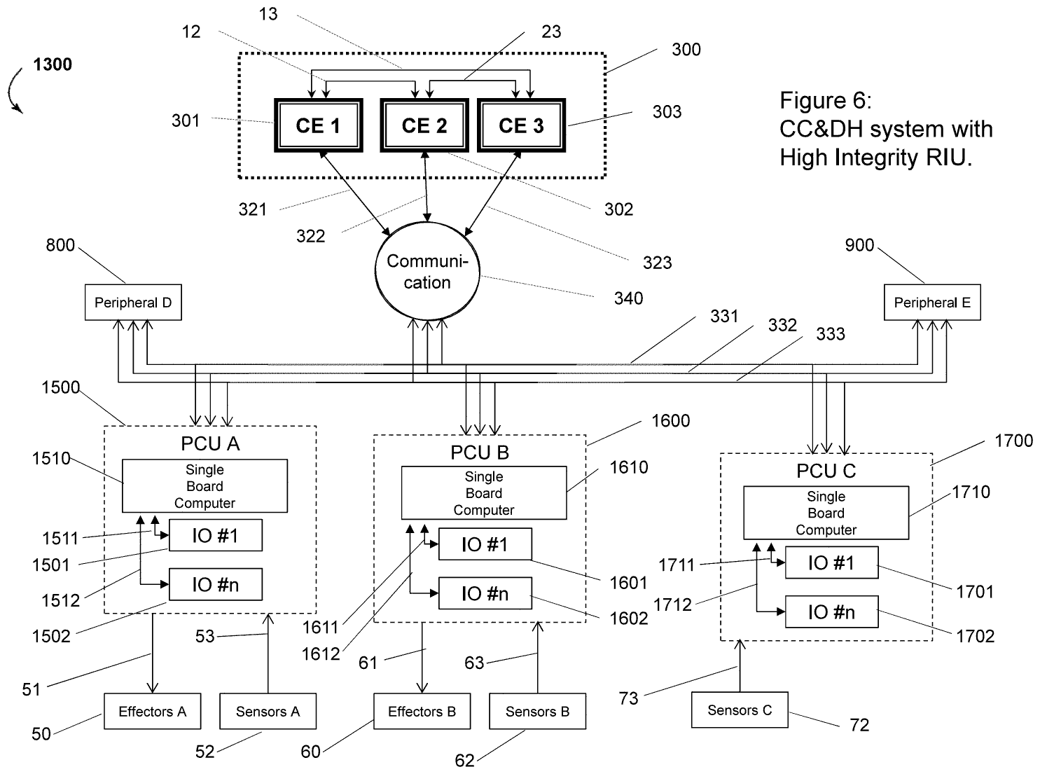

Focusing on FIG. 6, a functional block diagram of an exemplary fault tolerant Command, Control, and Data Handling (CC&DH) system [1300] with Standard Integrity Peripheral Control Unit (SPCU) [1500] [1600] [1700] is depicted. The CC&DH system [1300] receives sensor data from Sensors [52] [62] [72] and controls peripherals [50] [60] through interface connection [53] [63] [73] and interface connection [51] [61] respectively. Control of the CC&DH system [1300] is accomplished through the Reliable Computing Complex [1300] consisting of a plurality, but not less than two, Computing Elements [1301] [1302] [1303] with Cross Channel Data Link (CCDL) [12] [13] [23] interconnecting each Computing Element [301] [302] [303]. A minimum or three Computing Elements [301] [302] [303] are required for single fault tolerance while four are required for double fault tolerance; five are required for triple fault tolerance, and so forth. The Reliable Computing Complex [1300] communicates directly to a communication abstraction [340] through interface connection [331] [332] [333] which consists of data that is immune to byzantine failures. The communication abstraction [340] may be implemented using any number of choices including, but not limited to Ethernet, Time Triggered Gigabit Ethernet (TTGbE), wireless 802.11c, 13553B, SpaceWire, GPIB (IEEE-488). Optionally, a SPCU [1500] [1600] [1700] may be used to provide signal conditioning and/or data formatting to the peripheral devices [50] [52] [60] [62] [72]. In the example, the communication abstraction [340] comprises, but is not limited to a high integrity TTGbE switch. The communication abstraction [340] communicates directly to a plurality of SPCU [1500] [1600] [1700] device or alternately directly to peripheral devices using connections [331] [332] [333]. Use of a high integrity TTGbE switch as the communication abstraction [340] provides data that is immune to a byzantine data to the SPCU [1500] [1600] [1700].

Each Standard Integrity Peripheral Control Unit (SPCU) [1500] [1600] [1700] is comprised of a Single Board Computer [1510] [1610] [1710] communicating with an arbitrary number of Input Output functions [1501] [1502] [1601] [1602] [1701] [1702] over in internal parallel or serial interface connections [1511] [1512] [1611] [1612] [1711] [1712]. Those skilled in the art will recognize that each of the single board computer [1510] [1610] [1710] could be replaced with an alternate computing element such as a microcontroller, digital signal processor, or other. In the example, the interface connections [1511] [1512] [1611] [1612] [1711] [1712] comprises, but is not limited to a single lane PCIe. Those familiar with interconnects used in modern computers recognize that these interface connections could be implemented as cPCI, VME, SpaceWire, and many others. The SPCU [1500] [1600] [1700] is a less custom implementation and likely would cost less, but is not immune to byzantine failures. Many implementations of SPCU devices [1500] [1600] [1700] are available as catalog items from manufactures such as AiTech and SEAKR among others.

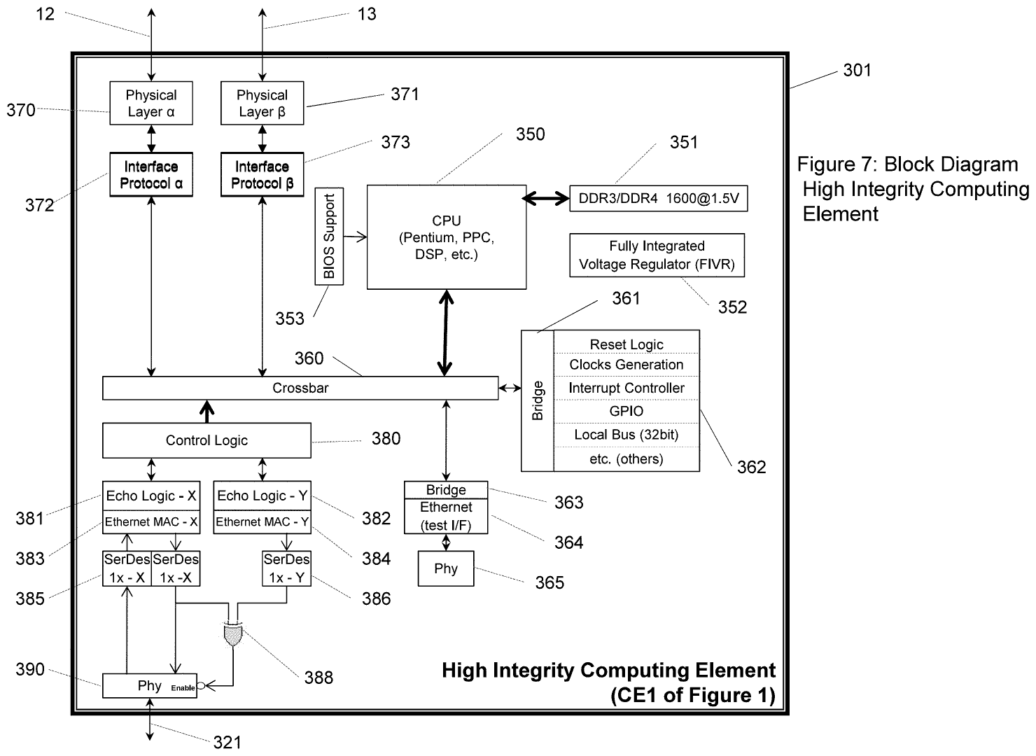

Turning to FIG. 7, a functional block diagram of an exemplary Computing Element [301] with Cross Channel Data Link (CCDL) and communication interface [321] controlled by a Central Processing Unit [350] and the devices necessary devices [351] [352] [353] [360] [361] [362] to support the CPU [350] operation. It should be appreciated by those of ordinary skill in the art of single board computer design or system on chip design will recognize that the implementation of the CPU [350] and the CPU support devices [351] [352] [353] [360] [361] [362] are existing art and can be implemented in many alternative configurations. Additionally a test interface consisting of a data bridge [363], Ethernet [364], and Physical Layer [365] are provided. Cross Channel Data Link consists of multiple channels which, at a minimum, must be one less than the number of Computing Elements [301] [302] [303] implemented in the Reliable Computing Complex [300]. Each channel of CCDL consists of Interface Protocol [372] [373] and a Physical Layer [370] [371]. Cross channel data link implementations are common in the community and can be implemented by those skilled in the art. Exemplary examples of their implementation include the Draper Laboratory Network Element and the Space Launch System computers. The unique implementation of byzantine fault protected data presented on communication interface [321] consists of a primary X-Lane channel consisting of Echo Logic-X [381] responsible with necessary synchronization with Echo Logic-Y [382] to assure that byzantine comparison of data can be completed, a monitor Y-Lane channel with Echo Logic-Y [381], a bit-by-bit, byte-by-byte, or message-by-message comparator [388] which can terminate the output of the Physical Layer [390] and thus data to communication interface [321]. When used with the high integrity Method [400], the Computing Element [301] is immune to byzantine faults. In the exemplary example, the implementation and protocol of the primary X-Lane and the monitor Y-lane is implemented as Ethernet consisting of the Ethernet MAC [381] [382] and serial to digital converter (SerDes) [385] [386]. Those skilled in the art of communication will recognize that many alternates such as, but not limited to, SpaceWire, PCI Express, Rapid IO, could be implemented as the communication abstraction [340] requiring corresponding implementation in CE [301] [302] [303].

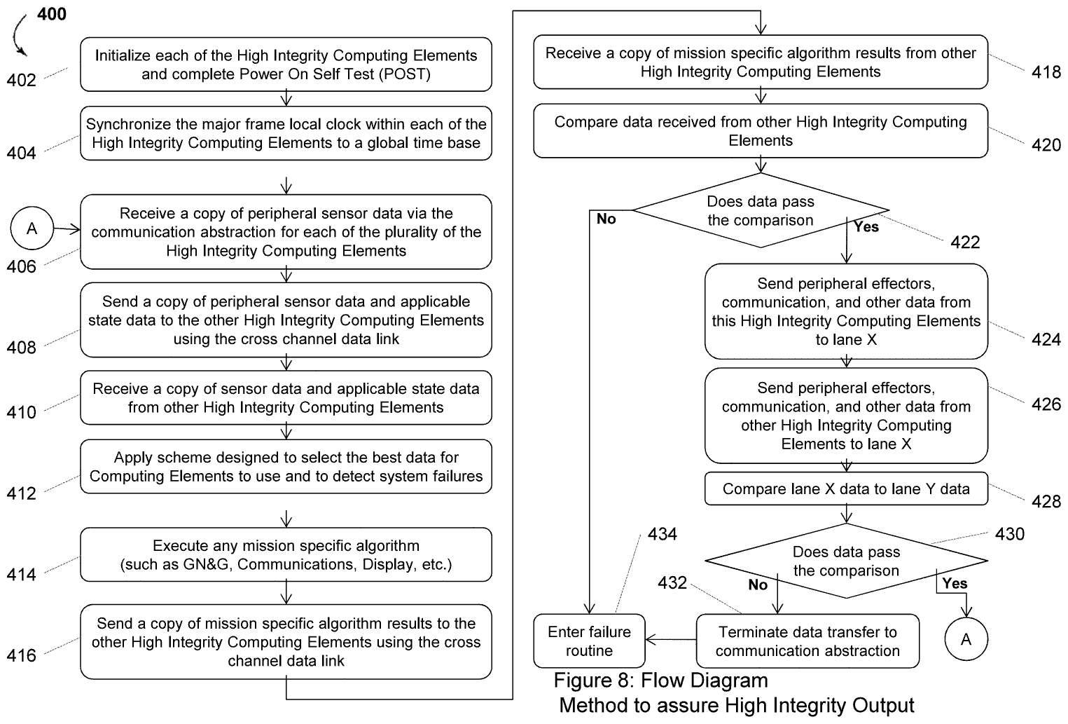

FIG. 8 is a flow chart depicting one embodiment of a method [400] of creating byzantine error free data to communication interface [321] [322] [323] and thus to peripheral devices [50] [60] [800] [900] in CC&DH system [300] [1300]. Method [400] is described here as being implemented in each CE [301] [302] [303 of FIG. 5 and FIG. 6]. At step [402], each CE [301] [302] [303] performs initialization and Power On Self Test (POST) controlled by CPU [350] of FIG. 7. Initialization and POST is common in the computer industry and is well understood as existing art. For highly synchronous systems, step [404] executes a frame synchronization of each of the CE [301] [302] [303] and any additional CE(s) as used to create greater than single fault tolerant redundancy. Implementation and Method to synchronize computers is well known in the industry. Exemplary examples of synchronization can be found in NASAs Orion spacecraft implemented using the TTGbE network and the Draper Laboratory Network Element.

In particular, the synchronization signal establishes the time base for the host computer [350]. In this embodiment, the synchronization signal is an interrupt signal. In an alternate asynchronous embodiment, the frame number becomes the synchronization requiring that CE 1 [301], CE 2 [302], and CE 3 [303] operate on the same frame.

At this point the Method [400] enters a continuous loop starting at step [406]. Step [406] acquires sensor peripheral data and all other data required by the mission specific algorithm [414]. For table driven systems, the data is made available directly by the Peripheral Control Unit [500] [600] [700] [800] [900] [1500] [1600] [1700] without action from the Computing Element [301] [302] [303] within the method and is part of the CC&DH system [3] [1300] and is acquired from the primary X-Lane channel [381] [383] [385] through the control logic [380] and “bent-pipe” crossbar [360]. Exemplary examples of this are the computer system in the Orion spacecraft, the 787 Flight control system, and the 777 Aircraft Information Management System. For command/response systems, step [406] executes the request and receives the response from the X-Lane channel [381] [383] [385] through the control logic] [380] and “bent-pipe” crossbar [360]. At this point all data necessary for CC&DH] [3] [3001 system are available.

At this point, the Method [400] completes the first data exchange consisting of each CE [301] [302] [303] and other CEs as necessary for greater than single fault tolerant systems. First data exchange consists of steps [408] and [410]. Step [408] provides for each CE [301] [302] [303] sending all peripheral sensor data acquired in step [406], system state data, and any data necessary for the mission specific algorithm [414] using data paths α, β, and others not shown where the number of data paths is one less than the number of CEs in the CC&DH system [3] [1300]. For asynchronous systems, frame number must also be included in the CDDL. At this point step [410] acquires the data from the other CE [301] [302] [303] controller using data paths α, β, and others not shown where the number of data paths is one less than the number of CEs in the CC&DH system [3] [1300]. In the example of FIG. 5 and FIG. 8, CE [301] 1 exchanges data with CE 2 [302] and CE 3 [303] over data lines [312] [313], CE 2 [302] exchanges data with CE 1 [301] and CE 3 [303] over data lines [312] [323], and CE 3 [303] exchanges data with CE 1 [301] and CE 2 [302] over data lines [312] [313].

The next step in Method [400] is to create a consistent set of peripheral sensor data. Redundant sensors rarely produce identical data, thus step [412] selects the best data for the CEs [301] [302] [303] to use and detect system failures. Different techniques may be applied for any given sensor and are well know by those skilled in fault tolerant systems. Several examples of these techniques include, but are not limited to taking the sensor averages, using a mid-value selection, discarding the high and low value, and applying a guard band to the data. Once all data is consistent, step [414] executes any mission specific algorithm such as, but not limited to, Guidance Navigation and Control, Launch, Landing, Communications, Health Management, and Display formatting.

At this point, the Method [400] completes the second data exchange, again consisting of data exchange between each CE [301] [302] [303] and other CEs as necessary for greater than single fault tolerant systems. Second data exchange consists of steps [416] [418]. Step [416] provides for each CE [301] [302] [303] sending all data produced as a result of sensor consistency [410] and the mission specific algorithm [414], using data paths α, β, and others not shown where the number of data paths is one less than the number of CEs in the CC&DH system [3] [1300]. For asynchronous systems, frame number must also be included in the CDDL. At this point step [418] acquires the data from the other CE [301] [302] [303] controller using data paths α, β, and others not shown where the number of data paths is one less than the number of CEs in the CC&DH system [3] [1300]. In the example of FIG. 5 and FIG. 8, CE [301] 1 exchanges data with CE 2 [302] and CE 3 [303] over data lines [12] [13], CE 2 [302] exchanges data with CE 1 [301] and CE 3 [303] over data lines [12] [23], and CE 3 [303] exchanges data with CE 1 [301] and CE 2 [302] over data lines [12] [13]. At [420] the received CCDL is compared requiring 100% exact comparison. If the comparison is successful, step [422] initiates step [424], else executed step [434] if the data fails. The failure routine is mission specific and not discussed here.

Finally, to produce byzantine failure immune data to the communication abstraction [340], step [424] presents the data intended for the communication interface [321] [322] [323] to the primary X-Lane implemented as Ethernet consisting of the Ethernet MAC [381] and serial to digital converter (SerDes) [385]. Similarly, step [426] presents the data set received from the cross channel data link [312] and validated as known good by step [420] to the monitor Y-Lane implemented as Ethernet consisting of the Ethernet MAC [384] and serial to digital converter (SerDes) [386]. It should be noted that the data presented to comparison logic [388] is from two separate sources and thus provides the necessary “truth” to assure a byzantine fault free data at interface connection [321]. As such step [428] completes a bit-by-bit, byte-by-byte, or message-by-message comparison of the X-lane and Y-lane data presented to the comparator mechanism] [388 of FIG. 7]. The X-lane data is also presented to the Physical Layer [390] which includes completion of step [430] in a YES condition by producing the data at the communication interface [321] [322] [323] and also provides the mechanism for terminating final transmission upon receiving a signal from the comparison mechanism [388] as indicated by a NO condition in step [430]. Methods of terminating a message within the physical layer are known in the industry and can include, but are not limited to, suppressing the drive voltage to the PHY, terminating or corrupting the message CRC, open the connection path to the final output, or short circuiting the final path signal to zero. Upon detection of an error at comparison mechanism [388], it is also desirable to execute step [430] in a NO condition and thus enter into an error routine of step [434].

Final completion of the method is to repeat the sequence starting with step [406] until final termination of the program is initiated.

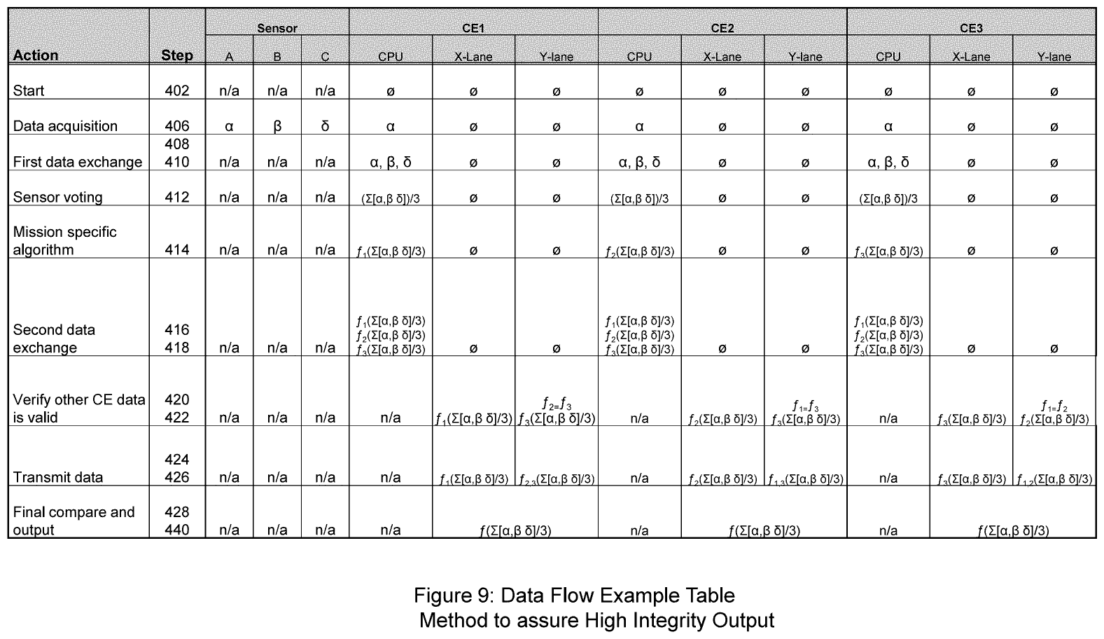

FIG. 9 is a table depicting an example of data processed by method [400] demonstrating the byzantine error free data movement within the present invention apparatus of FIG. 5, FIG. 6, and FIG. 7. Sensor information represented by α, β, and δ are presented to the CC&DH at sensors [51], [52], and [53] respectively, and acquired by CE 1 [301], CE 2 [302], and CE 3 [303] so that CE 1 embodies α, CE 2 embodies β, and CD 3 embodies δ. Step [408] [410] completes the data exchange using the Cross Channel Data Link (CCDL) resulting that each CE [301] [302] [303] embodies α, β, and δ. In the example of the table, an average algorithm is applied by step [413] wherein the resultant is the sum of α, β, and δ then divided by three. Each CE [301] [302] [303] then executes the mission unique algorithm represented by f(x) as step [414]. Each CE executes the identical algorithm and the resultants are noted as f₁(x) for CE 1 [301], f₂(x) for CE 2 [302], f₃(x) for CE 3 [303]. The second data exchange of step [416] [418] assures that each CE has all data f₁(x), f₂(x), and f₃(x). At this point, each f(x) embodies at each CE [301] [302] [303] could contain a byzantine error caused by a hardware fault. Step [420] [422] compare f(x) from the other CEs and assure they are identical, thus f2(x)=f₃(x) at CE 1 [301], f₁(x)=f₃(x) at CE 2 [302], and f₁(x)=f₂(x) at CE 3. Step [424] [426] present the X-Lane [381] [383] [385] and Y-Lane [382] [384] [386] data at each CE as f₁(x) to X-Lane and f_{2,3}(x) to the Y-Lane at CE 1 [301], f₂(x) to X-Lane and f_{1,3}(x) to the Y-Lane at CE 2 [302], f₃(x) to X-Lane and f_{1,3}(x) to the Y-Lane at CE 3 [303]. Step [428] utilizes apparatus [388] to compare the X-Lane and Y-Lane data. The X-Lane data is present at the PHY [390] and contains byzantine error free f(x) if there is a successful compare by apparatus [388]. If there is not a valid compare, data is suppressed and there is no data at the PHY [390].

What is claimed is:

1. A Reliable Computing Complex capable of producing byzantine error free data comprised of voting computers:
a plurality of High Integrity Computing Elements equal to the number of fault tolerant conditions desired plus one where each High Integrity Computing Element has the ability to execute fundamental computing,
a capability for each High Integrity Computing Element to accept data from a first arbitrary communication path
a capability to execute a plurality of data exchange between each of the number of High Integrity Computing Elements,
an independent primary and monitor data path allowing for comparison of data generated within each High Integrity Computing Element and data from the other an alternate source,
an apparatus to compare the primary and monitor data in real time or near real time,
a mechanism to terminate final output transmission to a first arbitrary communication path when an error is detected between the primary and monitor data.

2. The Reliable Computing Complex of claim 1, wherein the primary and monitor data path exist on the High Integrity Computing Element and the apparatus for comparison of primary and monitor data exists as a separate entity.

3. The Reliable Computing Complex of claim 1, wherein the primary and monitor data path and apparatus for comparison are integrated within the High Integrity Computing Element.

4. The Reliable Computing Complex of claim 1, wherein the Cross Channel Data Link is integrated on the High Integrity Computing Element with the method to assure data validity operated on within the High Integrity Computing Element.

5. The Reliable Computing Complex of claim 1, wherein the Cross Channel Data Link is a separate entity and from the High Integrity Computing Element and the method to assure data validity is operated on within either the separate entity or the High Integrity Computing Element.

6. The Reliable Computing Complex of claim 1, wherein the Computing Element Central Processing Unit and necessary support are comprised of a plurality of microelectronic devices.

7. The Reliable Computing Complex of claim 1, wherein the Computing Element Central Processing Unit and necessary support are comprised of a System on a Chip devices.

8. The Reliable Computing Complex of claim 1, wherein the Computing Element Central Processing Unit is a microprocessor or like device.

9. The Reliable Computing Complex of claim 1, wherein the Computing Element Central Processing Unit is a state machine.

10. A Method capable of producing byzantine error free data in a Reliable Computer embodied as voting computers comprising:
receiving data from sensors and other system inputs;
assuring that all Computing Elements within the Reliable Computer Complex access all applicable sensor and system data;
applying a plurality of algorithms to produce best data from redundant sensors;
ability to apply a plurality of mission specific algorithms to achieve the system performance;
provide separate data space and paths for presenting primary and monitor data to an apparatus for real time comparison; and
ability to detect errors and execute appropriate system response.

11. The Method of claim 10, wherein access to sensor and other external system data occurs as direct access to all data from the communication interface.

12. The Method of claim 10, wherein access to partial sensor and other external system data occurs as direct access to sensor data from the communication interface and partial data is acquired from other Compute Elements within the Reliable Computing Complex through Cross Channel Data Link.

13. The Method of claim 10, wherein best data is selected by each Compute Element using algorithms including, but not limited to calculating the average, using a mid-value selection, discarding the high and low value, and application of a guard band to the data.

14. The Method of claim 10, wherein the mission specific algorithm executed by each Compute Element includes, but is not limited to, Guidance Navigation and Control, Launch, Landing, Communications, Health Management, and Display formatting.

15. The Method of claim 10, wherein monitor data acquired from at least two other Compute Elements using a Cross Channel Data Link are verified by the by the Compute Element to be equivalent.

16. The Method of claim 10, wherein the Cross Channel Data Link is acquired by a direct Connection between each of the Compute Elements within the Reliable Computing Complex.

17. The Method of claim 10, wherein the Cross Channel Data Link is acquired utilizing the communication abstraction.

18. The Method of claim 10, wherein the Cross Channel Data Link is acquired by a direct Connection between each of the Compute Elements within the Reliable Computing Complex.

19. The Method of claim 10, wherein the Cross Channel Data Link is acquired utilizing the communication abstraction.

20. A Command Control and Data Handling (CC&DH) system comprised of the Reliable Computing Complex of claim 1 capable of producing byzantine error free data throughout the system:
a plurality of High Integrity Computing Elements equal to the number of fault tolerant conditions desired plus one where each High Integrity Computing Element has the ability to execute fundamental computing,
a communication abstraction connecting the Reliable Computing Complex directly to an arbitrary number of peripheral devices and/or Peripheral Control Units;
an arbitrary number of Peripheral Control Units as necessary to provide control, interface, and/or signal conditioning for sensors and effectors; and
a collection of peripheral devices including sensors and effectors necessary to achieve system objectives and performance.

21. The Command Control and Data Handling (CC&DH) system of claim 20 where the High Integrity Peripheral Control Units are replaced with Standard Integrity Peripheral Control Units.

22. The Command Control and Data Handling (CC&DH) system of claim 20 where the communication abstraction provides a High Integrity full crossbar switch between Compute Elements in the Reliable Computing Complex and the peripheral devices.

23. The Command Control and Data Handling (CC&DH) system of claim 20 where the communication abstraction provides a Standard Integrity full crossbar switch between Compute Elements in the Reliable Computing Complex and the peripheral devices.

24. The Command Control and Data Handling (CC&DH) system of claim 20 where the communication abstraction provides a one-to-many connection between the Compute Element and peripheral devices and Peripheral Control Units creating independent channelized fault zones.

25. The Command Control and Data Handling (CC&DH) system of claim 20 where the communication abstraction is FireWire/SpaceWire.

26. The Command Control and Data Handling (CC&DH) system of claim 20 where the communication abstraction is Time Triggered Ethernet.

27. The Command Control and Data Handling (CC&DH) system of claim 20 where the communication abstraction is embodied as wireless communication including, but not limited to Zigbee (802.15), WiFi (802.11), Bluetooth, and others.

28. The Command Control and Data Handling (CC&DH) system of claim 20 is table driven where the Compute Elements, Peripherals, and Peripheral Control Units exchange data with the communication abstraction as initiated by each individual unit based on time scheduled events contained as table data.

29. The Command Control and Data Handling (CC&DH) system of claim 20 is table driven where the Compute Elements, Peripherals, and Peripheral Control Units exchange data with the communication abstraction as initiated by the Compute Element.
